(19) United States
(12) Patent Application Publication
(10) Pub. No.: US 2006/0181601 A1
(43) Pub. Date: Aug. 17, 2006

(54) Image forming apparatus

(75) Inventor: Dae-yong Seo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/354,868

(22) Filed: Feb. 16, 2006

(30) Foreign Application Priority Data
Feb. 17, 2005 (KR) 2005-13014

(51) Int. Cl. B41J 2/375

(52) U.S. Cl. 347/223

(57) ABSTRACT

An image forming apparatus. The image forming apparatus includes a body of the image forming apparatus within which a developing part to develop an image on a print medium fed to the image forming apparatus is housed, a fixing unit installed within the body of the image forming apparatus to fix the image transferred to the print medium, a feeding unit to feed the print medium in such a way that a single side/both sides of a print medium is/are formed with an image/images while passing through the body of the image forming apparatus, a control unit to supply a voltage to the body of the image forming apparatus to control the body, the fixing unit, and the feeding unit of the image forming apparatus, and a cooling unit. The cooling unit is installed within the body of the image forming apparatus to cool the interior of the body of the image forming apparatus.

### CROSS-REFERENCE TO RELATED APPLICATION

This application claims the benefit of Korean Application No. 2005-13014, filed Feb. 17, 2005, in the Korean Intellectual Property Office, the disclosure of which is incorporated herein by reference.

### BACKGROUND OF THE INVENTION

1. Field of the Invention

An aspect of the present invention relates to an image forming apparatus, and, more particularly, to an image forming apparatus, which allows the cooling of an interior thereof, which is heated to a high temperature by heat generated at the time of the image forming apparatus being driven.

2. Description of the Related Art

Typically, an image forming apparatus, such as a composite machine, which is constructed by integrating a copying machine, a printer and a facsimile or other devices that operate similarly in a single appliance to compositely implement the operations, prints an image signal inputted into the image forming apparatus on a print medium.

One example of such a typical image forming apparatus is shown in FIG. 1. As shown in FIG. 1, the image forming apparatus has a developing part 10, a fixing unit 20, plural feeding rollers 30 and a control unit 40. The developing part 10 develops an image on a photosensitive drum 11, which is then developed on a print medium P. The image developed on the print medium P is fixed by a high temperature and a high pressure through the fixing unit 20. Here, the feeding rollers 30 convey the print medium P therethrough, so that the print medium P shall be discharged out of the image forming apparatus after the print medium is subjected to the developing and fixing processes. In addition, the control unit 40 supplies a voltage to the image forming apparatus so as to control the driving of print processes such as the developing and fixing processes.

Meanwhile, as a series of print processes to develop and fix an image on a print medium P as described above are performed in the image forming apparatus, the interior of the image forming apparatus is heated to a high temperature by the driving heat. That is, a large amount of heat is inputted by the control unit 40 so that the image forming apparatus performs developing and fixing processes. As a result, the interior of the image forming apparatus may be heated to a high temperature.

If the interior of the image forming apparatus is heated as described above, the components mounted within the image forming apparatus, such as the developing part 10, the fixing unit 20, the feeding rollers 30, and the control unit 40 may be deformed by the heat.

In particular, a print medium P may be heated while passing through the interior of the image forming apparatus, which is itself heated to a high temperature, whereby the quality of printing and discharging the print medium P will deteriorate. In addition, as the control unit 40 is heated by the high temperature, the driving of the image forming apparatus may not be smoothly controlled.

The problems caused by the high temperature may result in a failure of the image forming apparatus, thereby lowering the reliability of the image forming apparatus when a user uses the image forming apparatus. Therefore, a cooling of the interior of the image forming apparatus to a predetermined temperature or less is beneficial.

### SUMMARY OF THE INVENTION

Accordingly, aspects of the present invention solve the above-mentioned and/or other problems. Further, an aspect of the present invention is to provide an image forming apparatus having an improved construction to allow the cooling of the interior thereof that is heated to a high temperature.

In order to achieve the above-mentioned and/or other aspects, there is provided an image forming apparatus comprising: a body of the image forming apparatus within which a developing part for developing an image on a print medium fed to the image forming apparatus is housed; a fixing unit installed within the body of the image forming apparatus to fix the image transferred to the print medium; a feeding unit to feed the print medium in such a way that a single side/both sides of a print medium is/are formed with an image/images while passing through the body of the image forming apparatus; a control unit to supply a voltage to the body of the image forming apparatus to control the body, the fixing unit, and the feeding unit of the image forming apparatus; and a cooling unit installed within the body of the image forming apparatus to cool the interior of the body of the image forming apparatus. The cooling unit concurrently cools the feeding unit, the fixing unit and the control unit. The cooling unit may comprise: a first cooling member to cool the fixing unit and the print medium when the print medium passes through the fixing unit; and a second cooling member to cool the control unit and the feeding unit neighboring the control unit. The first cooling member is positioned above the fixing unit.

The feeding unit comprises: a first passageway to discharge the print medium after one side of the print medium is printed with an image; and a second passageway to reverse a moving direction of the print medium which has passed through the first passageway and then to position the print medium so as to re-enter the first passageway to print an image on the other side of the print medium.

Here, the control unit is installed between the first passageway and the second passageway.

The first cooling member is positioned above the first passageway so as to cool the print medium while the print medium is passing through the first passageway.

In addition, the body of the image forming apparatus further comprises a rear panel provided to correspond to an area where the print medium is reversed while being entered into the second passageway from the first passageway, and that the second cooling member is installed on the rear panel to concurrently cool the print medium and the control unit. The rear panel may be installed to be capable of opening and shutting, wherein the rear panel includes a rear cover to support the second cooling member. The rear panel may be formed with a guide rib to guide and convey the print medium while the print medium is being conveyed and passing through the first and second passageways.

The rear panel comprises: a rear panel body fixed to the body of the image forming apparatus; and a rear cover installed in the body of image forming apparatus to be capable of opening and shutting, the rear cover being provided with a mounting area to mount the second cooling member.

Meanwhile, the first and second cooling members may be first and second fans to cause external air to flow into the body of the image forming apparatus to cool the interior of the body of the image forming apparatus.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which: The above aspects and features of the present invention will be more apparent from the description for certain embodiments of the present invention taken with reference to the accompanying drawings, in which:

FIG. 1 is a cross-sectional view schematically showing a conventional image forming apparatus;

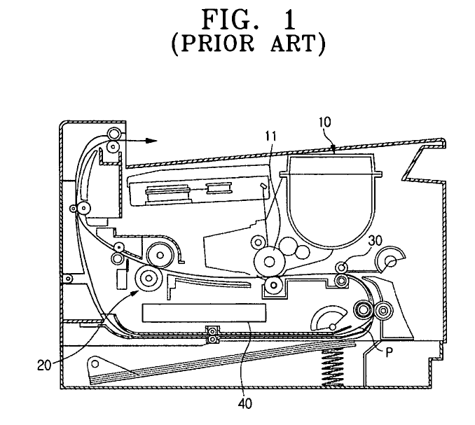

FIG. 2 is a cross-sectional view schematically showing an image forming apparatus according to an embodiment of the present invention;

FIG. 3 is a perspective view schematically showing a rear cover for the image forming apparatus of FIG. 2; and

FIG. 4 is a cross-sectional view schematically showing an image forming apparatus according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

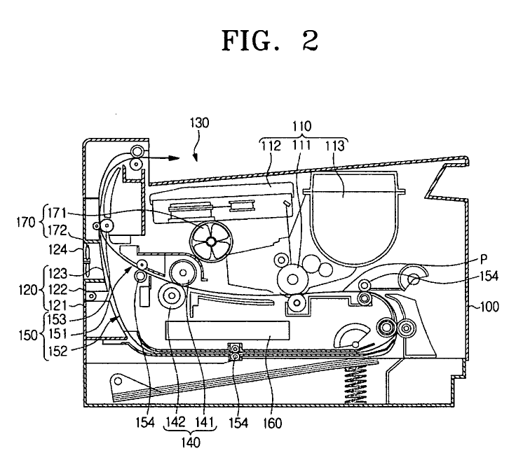

Referring to FIG. 2, an image forming apparatus according to an embodiment of the present invention includes a body 100 of the image forming apparatus, a fixing unit 140, a feeding unit 150, a control unit 160, and a cooling unit 170. The body 100 of the image forming apparatus also houses a developing part 110 to develop an image on a print medium P that is fed to the image forming apparatus. The developing part 110 comprises a photosensitive drum 111, a laser scanning unit (LSU) 112, and a developing device 113.

The surface of the photosensitive drum 111 is scanned by the laser scanning unit 112, so that a given electrostatic latent image is formed on the surface. The electrostatic latent image, formed in this manner, is developed as a visible image by one or more developers contained in the developing device 113. This visible image is then transferred to the print medium P while the print medium P passes through the developing part 110. As a result, an image is developed on the print medium P.

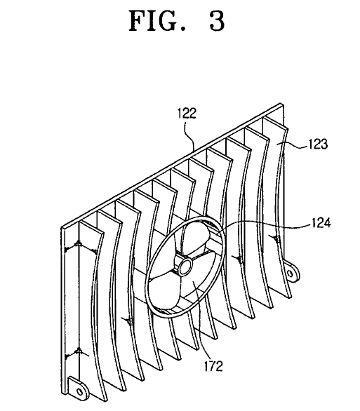

In addition, the body 100 of the image forming apparatus has a rear panel 120 that is selectively opened with respect to the body 100. The rear panel 120 has a rear panel body 121 and a rear cover 122 as shown in FIGS. 2 and 3. The rear panel body 121 is fixed with respect to the body 100 of the image forming apparatus, and the rear cover 122 is mounted on the body 100 of the image forming apparatus by, for example, a hinge. As such, the rear cover 122 is capable of opening and shutting with respect to the body 100 of the image forming apparatus.

The fixing unit 140 is installed within the body 100 of the image forming apparatus to fix the image that is transferred to the print medium P and comprises a heating roller 141 to heat the print medium P to a high temperature, and a compressing roller 142 to apply a high pressure to the print medium P.

The feeding unit 150 feeds the print medium P such that a single side and/or both sides of the print medium P is/are formed with an image/images while the print medium P passes through the interior of the body 100 of the image forming apparatus. That is, the feeding unit 150 feeds the print medium P such that the print medium P is conveyed via the developing part 110 and the fixing unit 140 installed within the body 100 of the image forming apparatus. To this end, the feeding unit 150 includes first and second passageways 151, 152.

The first passageway 151 discharges the print medium P out of the image forming apparatus after an image has been formed on one side of the print medium P. The second passageway 152 reverses the print medium P after the print medium P has passed through the first passageway and positions the print medium P so as to allow the print medium P to re-enter the first passageway 151 with an orientation such that an image may be printed on the other side of the print medium P.

Here, plural feeding rollers 153, 154 are installed on the first and second passageways 152 to convey the print medium P. The feeding roller 153 installed at the junction between the first passageway 151 and the second passageway 152 are driven forward and in reverse so as to reverse the moving direction of the print medium P and to introduce the print medium P into the second passageway 152.

More specifically, the feeding roller 153 rotates in the forward direction in the first passageway 151 so as to convey the print medium P, of which one side is formed with an image, toward a paper discharging unit 130. Thereafter, if the print medium P has been conveyed to the paper discharge unit 130 to a certain extent, the feeding roller 153 is driven in reverse. Then, the print medium P is reversed and conveyed along the second passageway 152, so that an image may be formed on the other side of the print medium P.

Meanwhile, according to another embodiment of the invention, the rear panel 120 is provided to correspond to the area where the print medium P is reversed while being positioned to enter the second passageway 152 from the first passageway 151. In this position, the rear cover 122 selectively opens so as to allow for a discharge of the print medium P, of which the one side is formed with an image, out of the image forming apparatus. Thus, discharging the print medium out of the paper discharging unit 130, provided on the top of the body 100 of the image forming apparatus, is not required. In addition, by opening the rear cover 122, prevention of a jamming phenomenon, which may be otherwise caused within the body 100 of the image forming apparatus, is possible.

With reference to FIG. 3, as shown, guide ribs 123 are formed on the rear panel body 121 and the rear cover 122 to guide and convey a print medium P while the print medium passes through the first and second passageways 152.

The control unit 160 supplies voltage to the body 100 of the image forming apparatus to control the driving of the body 100 of the image forming apparatus. Considering the utilization of the space within the body 100 of the image forming apparatus, according to an embodiment of the invention, the control unit 160 is installed between the first and second passageways 151, 152. The control unit 160 may employ an SMPS (Switching Mode Power Supply) which converts an AC line frequency to a DC line frequency to transform electric power. Because such an SMPS is well known in the art, detailed description thereof is omitted.

The cooling unit 170 is mounted within the body 100 of the image forming apparatus to cool the interior of the body 100. More specifically, the cooling unit 170 may concurrently cool the feeding unit 150, the fixing unit 140 and the control unit 160. The cooling unit 170 includes first and second cooling members, which, according to an embodiment of the invention, are first and second fans 171, 172. Of course, it is understood that the first and second cooling members of the cooling unit 170 are not limited to comprising first and second fans 171 and 172, respectively. In fact, various modified elements may be employed to cool the interior of the body 100. For example, the cooling unit 170 may include a cooling device such as a cooling laminate having a characteristic of high heat conductivity or a liquid coolant capable of cooling the interior of the body 100 of the image forming apparatus.

The first fan 171 cools the fixing unit 140 and the print medium P as the print medium P passes through the fixing unit 140. As such, the first fan 171 is positioned above the fixing unit 140 and the first passageway 151. In addition, the first fan 171 is mounted on one side wall of the body 100 of the image forming apparatus to cool the heated air within the body 100. The second fan 172 cools the control unit 160 and the feeding unit 150 neighboring the control unit 160. Here, the second fan 172 is mounted on the rear panel 120. In a particular embodiment of the invention, the second fan 172 is mounted on the rear cover 122. Here, the rear cover 122 is provided with a fan mounting area 124, and the second fan 172 is mounted in the fan mounting area 124.

According to aspects of the invention, the air flow rate introduced into the interior of the body 100 of the image forming apparatus by the second fan 172 for cooling is to be not faster than the conveying rate of the print medium P conveyed along the guide ribs 123 on the rear cover 122. This prevents the print medium P from being interfered with by the second fan 172 or the air flow while the print medium P is being conveyed.

Now, the operation of the image forming apparatus, according to the embodiments of the present invention configured as described above, is described with reference to the accompanying drawings. As shown in FIGS. 2 and 3, a print medium P is fed into the body 100 of the image forming apparatus and made to enter into the first passageway 151. The print medium P is then conveyed by the plural feeding rollers 154. The print medium P is formed with an image while passing through the developing part 110 and the fixing unit 140 in sequence and is then discharged to the paper discharge unit 130. Here, the print medium P may be discharged toward the rear cover 122 of the rear panel 120 which is selectively opened, rather than toward the paper discharging unit 130, after the print medium P has been conveyed via the first passageway 151.

If the print medium P passes through the first passageway 151, the plural feeding rollers 153, 154 are forwardly rotated and the first and second fans 171, 172 are both driven to cool the interior of the body 100 of the image forming apparatus.

In particular, the first fan 171 cools the fixing unit 140 and the print medium P as the print medium P passes through the fixing unit 140. Here, the cooled print medium P prevents the top of the body 100 of the image forming apparatus from being heated while being discharged to and loaded onto the paper discharging unit 130, which is formed on the top of the body 100 of the image forming apparatus. In addition, the second fan 172 cools the high temperatures produced as the control unit 160 supplies a voltage to the body 100 of the image printing apparatus to control the image forming apparatus.

If a forming of an image on the other side of the print medium P on which an image is already formed on one side thereof is desired, the feeding roller 153 is rotated in reverse before the print medium P is discharged out of the image forming apparatus to reverse the movement of the print medium P. The reversed print medium P enters into the second passageway 152 along the guide ribs 123 and then enters into the first passageway 151 via the second passageway 152. At this time, when the print medium P enters into the second passageway 152, the print medium P is again cooled by the second fan 172 installed on the rear cover 122.

The print medium P, which has entered into the first passageway 151 again, is formed with an image on the other side thereof as the print medium P passes through the developing part 110 and the fixing unit 140 in sequence. The print medium P is again conveyed along the first passageway 151 and is again cooled by the first fan 171 positioned above the first passageway 151.

By providing the first and second fans 171, 172 as mentioned above, an efficient cooling of the interior of the body 100 of the image forming apparatus is possible. Moreover, by installing the second fan 172 in the fan mounting area 124 provided in the rear cover 122, the utilization of space in the body 100 of the image forming apparatus may be enhanced.

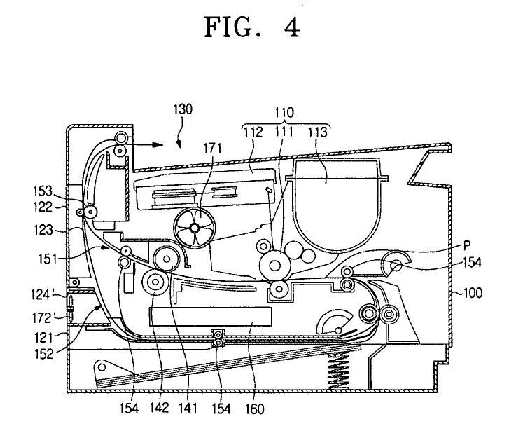

FIG. 4 is a cross-sectional view schematically showing another embodiment of the present invention. As shown in the drawing, the basic construction of the image forming apparatus, according to the present embodiment of the present invention, which includes a body 100 of the image forming apparatus, a fixing unit 140, a feeding unit 150, a control unit 160, and a cooling unit 170, is similar to the above-mentioned embodiment. Accordingly, descriptions of overlapped features are omitted and only the characteristic feature of the present embodiment is described. Meanwhile, the constituent elements of the present embodiment identical to those of the above-mentioned embodiment are indicated by those reference numerals used in describing the above-mentioned embodiment.

According to the second embodiment of the invention, the second fan 172′ is not installed on the rear cover 122 but, rather, on the rear panel body 121. That is, a fan mounting area 124′ is formed in the rear panel body 121 and the second fan 172′ is mounted in the fan mounting area 124′. Here, the second fan 172′ is mounted on the rear panel body 121 located below the rear cover 122.

With this arrangement, the second fan 172′ is installed more closely to the control unit 160, so that the second fan 172′ cools the control unit 160 and a print medium P which passes through the second passageway. Furthermore, because the second fan 172′ is installed on the rear panel body 121, which is fixed to the body 100 of the image forming apparatus, rather than on the rear cover 122, which is selectively opened, the power supply may be more easily connected to the second fan 172′.

As is described above, according to aspects of the invention, because the cooling unit 170 including first and second fans 171, 172; 172′ is provided, the interior of the body 100 of the image forming apparatus heated by the heat produced when the image forming apparatus is operated may be efficiently cooled. Moreover, because a print medium P is cooled by the first and second fans 171 and 172 and 172′ while passing through the first and second passageways 151, 152, the efficiency of printing and discharging the print medium P may be enhanced. As a result, the problems caused in the image forming apparatus due to a high temperature may be at least alleviated or solved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, comprising:
a body of the image forming apparatus within which a developing part to develop an image on a print medium fed to the image forming apparatus is housed;
a fixing unit installed within the body of the image forming apparatus to fix the image transferred to the print medium;
a feeding unit to feed the print medium in such a way that a single side/both sides of a print medium is/are formed with an image/images while passing through the body of the image forming apparatus;
a control unit to supply a voltage to the body of the image forming apparatus to control the body, the fixing unit, and the feeding unit of the image forming apparatus; and
a cooling unit installed within the body to cool the interior of the body.

2. The image forming apparatus as claimed in claim 1, wherein the cooling unit concurrently cools the feeding unit, the fixing unit and the control unit.

3. The image forming apparatus as claimed in claim 2, wherein the cooling unit comprises:
a first cooling member to cool the fixing unit and the print medium when the print medium passes through the fixing unit; and
a second cooling member to cool the control unit and the feeding unit.

4. The image forming apparatus as claimed in claim 3, wherein the first cooling member is positioned above the fixing unit.

5. The image forming apparatus as claimed in claim 3, wherein the feeding unit comprises:
a first passageway to discharge the print medium after an image is printed on one side of the print medium; and
a second passageway to reverse a moving direction of the print medium which has passed through the first passageway and then to position the print medium so as to re-enter the first passageway to print an image on the other side of the print medium.

6. The image forming apparatus as claimed in claim 5, wherein the control unit is installed between the first passageway and the second passageway.

7. The image forming apparatus as claimed in claim 6, wherein the first cooling member is positioned above the first passageway so as to cool the print medium while the print medium passes through the first passageway.

8. The image forming apparatus as claimed in claim 5, wherein the body of the image forming apparatus comprises a rear panel provided to correspond to an area where the moving direction of the print medium is reversed while the print medium enters into the second passageway from the first passageway, and wherein the second cooling member is installed on the rear panel to concurrently cool the print medium and the control unit.

9. The image forming apparatus as claimed in claim 8, wherein the rear panel opens and shuts and comprises a rear cover to support the second cooling member.

10. The image forming apparatus as claimed in claim 8, wherein the rear panel is formed with a guide rib to guide and to convey the print medium while the print medium is conveyed and passed through the first and second passageways.

11. The image forming apparatus as claimed in claim 8, wherein the rear panel comprises:
a rear panel body fixed to the body of the image forming apparatus; and
a rear cover installed in the body of image forming apparatus to open and shut, the rear cover being provided with a mounting area on which the second cooling member is mounted.

12. The image forming apparatus as claimed in claim 3, wherein the first and second cooling members are first and second fans to cause external air to flow into the body of the image forming apparatus so as to cool the interior of the body of the image forming apparatus.

13. An image forming apparatus, including a fixing unit to fix an image to a print medium, a feeding unit to feed the print medium through the apparatus, and a control unit to control the fixing unit and the feeding unit, the apparatus comprising:
a first passageway along which the print medium is fed with a first orientation;
a first cooling member to cool the fixing unit and the print medium when the print medium is fed along the first passageway;
a second passageway along which the print medium is fed to be positioned to re-enter and be fed through the first passageway with a second orientation; and
a second cooling member to cool the control unit, the feeding unit, and the print medium when the print medium is fed along the second passageway.

14. The apparatus according to claim 13, further comprising a body to house a developing part to develop the image, the developing part including a photosensitive drum, a laser scanning unit, and a developing device.

15. The apparatus according to claim 13, further comprising a body including a rear panel to be selectively opened with respect to the body, the rear panel having a rear panel body fixed with respect to the body, and a rear cover to open and shut with respect to the body.

16. The apparatus according to claim 15, wherein the fixing unit is installed within the body to fix the image to the print medium and comprises:
a heating roller to heat the print medium to a high temperature; and
a compressing roller to apply a high pressure to the print medium.

17. The apparatus according to claim 16, wherein the feeding unit feeds the print medium such that a single side and/or both sides of the print medium is/are formed with an image/images.

18. The apparatus according to claim 17, wherein the first passageway discharges the print medium out of the image forming apparatus to a certain extent after an image has been formed on one side of the print medium, and the second passageway reverses the moving direction of the print medium after the print medium has passed through the first passageway and positions the print medium so as to allow the print medium to re-enter the first passageway with the second orientation.

19. The apparatus according to claim 18, further comprising at least two set of feeding rollers installed along the first and second passageways to convey the print medium in forward and reverse directions, at least one set being installed at a junction of the first and second passageways.

20. The apparatus according to claim 19, wherein the one set of feeding rollers installed at the junction of the first and second passageways rotates forward to convey the print medium, of which one side is formed with the image, so as to discharge the print medium, and, if the print medium has been conveyed to discharge to the certain extent, the one set of feeding rollers is driven in reverse to convey the print medium along the second passageway.

21. The apparatus according to claim 13, further comprising a rear panel to correspond to an area where the print medium is conveyed along the second passageway, the rear panel being selectively opened to allow for a discharging of the print medium from the first passageway when the print medium has an image formed on one side thereof.

22. The apparatus according to claim 21, further comprising guide ribs formed on the rear panel to guide and convey the print medium.

23. The apparatus according to claim 13, wherein the control unit is installed between the first and second passageways.

24. The apparatus according to claim 13, wherein the first and second cooling members comprise fans.

25. The apparatus according to claim 13, wherein the first cooling member is positioned above the fixing unit and the first passageway.

26. The apparatus according to claim 21, wherein the rear panel comprises a rear cover to selectively open an interior of the apparatus, the rear cover, having a fan mounting area therein, and wherein the second cooling member is mounted on the fan mounting area of the rear cover.

27. The apparatus according to claim 13, wherein an air flow rate introduced into the interior of the apparatus by the second cooling member is not faster than a conveying rate of the print medium when the print medium is conveyed along the second passageway.

28. The apparatus according to claim 21, wherein the rear panel comprises and a panel body to remain stationary with respect to the apparatus, the rear panel body having a fan mounting area therein, and wherein the second cooling member is mounted on the fan mounting area of the rear panel body.
